(19) United States
(12) Patent Application Publication
(10) Pub. No.: US 2021/0394542 A1
(43) Pub. Date: Dec. 23, 2021

(54) METHOD FOR PRINTING A HEADSTONE

(71) Applicant: Robert Krzykawski, Belmont, CA (US)

(72) Inventor: Robert Krzykawski, Belmont, CA (US)

(21) Appl. No.: 17/355,649

(22) Filed: Jun. 23, 2021

Related U.S. Application Data
(60) Provisional application No. 63/042,888, filed on Jun. 23, 2020.

(51) Int. Cl. B41M 5/00; B41M 7/00

(52) U.S. Cl. CPC B41M 5/007; B41M 5/0011; B41M 7/0081; B41M 7/0045

(57) ABSTRACT

A method for forming one or more graphics on a headstone includes pre-processing a marking surface of the headstone. The pre-processing includes cleaning of the marking surface. The method also includes printing the one or more graphics on the marking surface and applying a coating on the marking surface such that the one or more graphics is covered with coating Moreover, the method includes curing the coating applied on the one or more graphics by exposing the coating to ultraviolet radiations to harden the coating.

### CROSS-REFERENCE TO RELATED APPLICATION

This application claims benefit of priority under 35 U.S.C. section 119(e) of the U.S. Provisional Patent Application Ser. No. 63/042,888, filed Jun. 23, 2020, entitled “METHOD OF PRINTING A HEADSTONE”, which is hereby incorporated by reference in its entirety.

### TECHNICAL FIELD

The present disclosure pertains to a method of forming graphics on a headstone. More particularly, the present disclosure pertains to a method for printing graphics on a headstone.

### BACKGROUND

A headstone/tombstone/gravestone/cenotaph includes a plurality of graphics incised onto a surface of the headstone for displaying information of a deceased or any messages from the loved ones. The graphics may be incised by chiseling, etching or by using laser etching onto the surface. However, the process required for incising the graphics is time consuming, labor intensive and generates plenty of dust and waste products that may be hazardous to an artist and the environment. Also, the quality of the graphic is not up to the mark and depends on the skills of the artist.

### SUMMARY

According to an aspect of the disclosure a method for forming one or more graphics on a headstone is provided. The method includes pre-processing a marking surface of the headstone. The pre-processing includes cleaning of the marking surface. The method further includes printing, by a printer, the one or more graphics on the marking surface, and applying a coating on the marking surface such that the one or more graphics is covered with coating. The method furthermore includes curing the coating applied on the one or more graphics by exposing the coating to ultraviolet radiations to harden the coating.

In an embodiment, the cleaning the marking surface including blowing dry air on the marking surface.

In an embodiment, a plurality of cleaning agents is used to facilitate the cleaning of the marking surface.

In an embodiment, the preprocessing of the marking surface is performed for a predetermined time duration.

In an embodiment, the predetermined time duration is selected based on a material of the marking surface.

In an embodiment, the printer is a digital printer to facilitate a high resolution printing on the marking surface.

In an embodiment, the printer prints the one or more graphics on the marking surface by diffusing a plurality of colors on the marking surface.

In an embodiment, printing of the one or more graphics on the marking surface includes curing the one or more graphics by treating the one or more graphics with ultraviolet rays.

In an embodiment, the coating is a UV durable coating.

In an embodiment, the curing of the coating is performed for a predefined duration.

In an embodiment, the curing of the coating is performed after the application of the coating on the one or more graphics.

In an embodiment, the curing of the coating is performed during the application of the coating on the one or more graphics.

For a more complete understanding of the present disclosure, reference is made to the following detailed description and accompanying drawings. In the drawing, like reference characters refer to like parts throughout the views in which:

### BRIEF DESCRIPTION OF THE DRAWINGS

FIG. 1 illustrates a headstone placed on a memorial, in accordance with an embodiment of the disclosure; and

FIG. 2 illustrates an exemplary method for printing a graphic on the headstone, in accordance with an embodiment of the disclosure.

### DETAILED DESCRIPTION

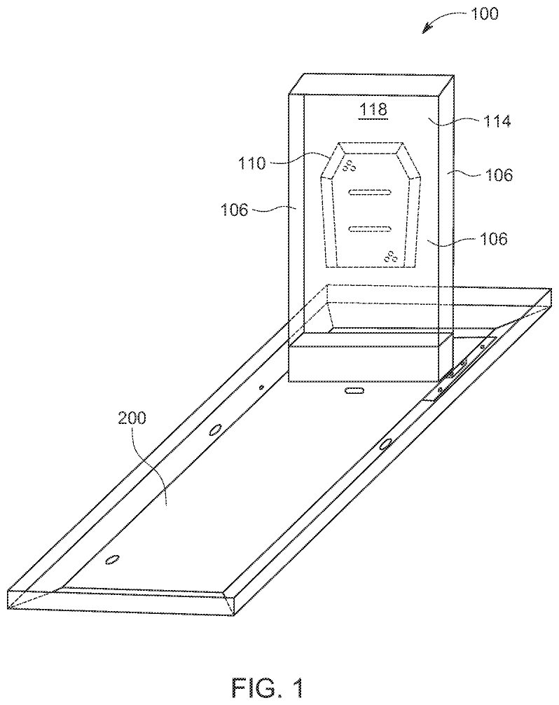

Referring to FIG. 1, a headstone/tombstone/gravestone 100 is placed over a grave/memorial 200 of a deceased is shown. The headstone 100 includes one or more graphics 110 including an image and/or an inscription having an information of the deceased, such as name, date of birth, date of death along with any other message from the loved ones. As shown, the headstone 100 may include one or more walls 106 having the one or more graphics 110 on an outer surface 114 of the one of more walls 106 defining a marking surface 118 of the headstone 100. Further, the headstone 100 may be made of materials like stone or rocks of various types such as but not limited to natural stone, composite stone, marble, granite, sandstone, slate, limestone or any other composite material such as solid glass, engineered glass, solid plastic, concrete, cement or any other material known in the art.

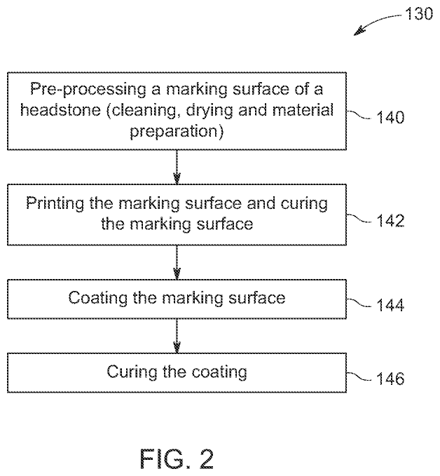

Referring to FIG. 2 an exemplary method 130 for forming or printing one or more graphics 110 on the marking surface 118 of the headstone 100 is shown. At a step 140, a pre-processing of the marking surface 118 is performed. In an exemplary embodiment, the pre-processing includes cleaning the marking surface 118 for removing impurities to facilitate a high resolution printing on the marking surface 118. In an embodiment, the marking surface 118 may be cleaned by blowing dry air or by using a pressurized/compressed air. In an embodiment, for cleaning the marking surface 118 various cleaning agents may be used. In an embodiment, the pre-processing of the marking surface 118 may be performed for a predetermined time duration. In an embodiment, the predetermined time duration may be selected based on the material of the marking surface 118.

Thereafter, at a step 142 of the method 130, a printing of the one or more graphics 110 on the marking surface 118 is performed. For so doing, a printer is utilized. In an embodiment, the marking surface 118 is an integral part of the headstone 100. In certain other implementations, the marking surface 118 is a separate plate on which the one or more graphics 110 is printed. In such a case, subsequent to the printing of the one or more graphics 110 on the marking surface 118, the plate is attached to the one or more walls 106. In an embodiment, the printer may print the one or more graphics 110 on the marking surface 118 by diffusing a plurality of colors on to the marking surface 118. For example, the printer may fuse five colors in a varied proportion to print the one or more graphics 110 on the marking surface 118 of the headstone 100. In an embodiment, the printer may be a digital printer for facilitating the high resolution printing on the marking surface 118. In an embodiment, a curing of the one or more graphics 110 printed on the marking surface 118 is also performed during the printing of the one or more graphics 110. In such a case, the curing may be performed by exposing/treating the one or more graphics 100 to UV (ultraviolet) radiations/rays. Owing to the curing, the plurality of colors gets dried and hardened quickly, thereby improving a retention of the one or more graphics 110 on the marking surface 118.

Upon printing the one or more graphics 110 on the marking surface 118, the method 130 moves to a step 144. At the step 144, a coating is applied on the marking surface 118 such that the one or more graphics 110 is covered with the coating. In an embodiment, the coating may be UV (ultraviolet) durable coating. In an embodiment, the coating may be applied by the printer or by any other suitable mechanism known in the art.

Thereafter, the method 130 moves to a step 146, in which a curing of the coating applied on the marking surface 118 (i.e. the one or more graphics 110) is performed. For curing the coating, the one or more graphics 110 and the coating applied on the one or more graphics 110 is exposed to a UV light/radiations. For so doing, an ultraviolet light/radiation discharger may be utilized. The exposure to the UV radiations facilitates in curing of the coating disposed on the one or more graphics 110 and/or the marking surface 118, and thereby hardens the coating. Accordingly, the one or more graphics 110 attains improved durability against fading and mechanical abrasion. In an embodiment, the curing may be performed for a predefined duration. Although, the curing of the coating applied on the one or more graphics 110 is contemplated after the application of the coating, it may be appreciated that the curing may be performed during the application of the coating on the one or more graphics 110 or the marking surface 118.

The advantage of the digitally printing the graphics 110 on the marking surface 118 of the headstone 100 is now explained. The printing process prints the high resolution image/graphic on the headstone 100 or any other material such as stone or rock of any color. The one or more graphics 110 printed is durable to fading against the UV (ultraviolet) light or sunlight and also durable against any mechanical abrasion. In addition, the printing process requires less time and is less labor intensive as compared to the time required to chisel the headstone 100 while engraving a plurality of voids and filling the voids with desired colors. The one or more graphics 110 printed on the headstone 100 is of high quality due to the appropriate proportion of colors used, creating a true color rendering on the marking surface 118. In addition, the printing process has fewer environmental impacts as compared to the hazardous process of chiseling/cutting the stone that generates dust and waste that is dangerous for an artist and the environment. Further, the marking surface 118 of the headstone 100 may be re-used by reprinting the marking surface 118. For reprinting the marking surface 118 may be polished/rubbed for removing the one or more graphics 110. A new graphic may be re-printed on the marking surface 118 and the headstone 100 may be re-used with the new graphic. The rubbing and polishing may be done in cases where the marking surface 118 is hard to print or where material is required to be removed for printing. Furthermore, the one or more graphics 110 printed on the headstone 100 is dried and hardened quickly, thereby the headstone 100 is ready to be used and may be packed and transported directly after the printing.

It should be understood that the foregoing description is only illustrative of the aspects of the disclosed embodiments. Various alternatives and modifications can be devised by those skilled in the art without departing from the aspects of the disclosed embodiments. Accordingly, the aspects of the disclosed embodiments are intended to embrace all such alternatives, modifications, and variances that fall within the scope of the appended claims. Further, the mere fact that different features are recited in mutually different dependent or independent claims does not indicate that a combination of these features cannot be advantageously used, such as a combination remaining within the scope of the aspects of the disclosed embodiments.

What is claimed is:

1. A method for forming one or more graphics on a headstone, the method comprising:
pre-processing a marking surface of the headstone, wherein the pre-processing includes cleaning of the marking surface;
printing, by a printer, the one or more graphics on the marking surface;
applying a coating on the marking surface such that the one or more graphics is covered with coating; and
curing the coating applied on the one or more graphics by exposing the coating to ultraviolet radiations to harden the coating.

2. The method of claim 1, wherein the cleaning the marking surface including blowing dry air on the marking surface.

3. The method of claim 1, wherein a plurality of cleaning agents is used to facilitate the cleaning of the marking surface.

4. The method of claim 1, wherein the preprocessing of the marking surface is performed for a predetermined time duration.

5. The method of claim 4, wherein the predetermined time duration is selected based on a material of the marking surface.

6. The method of claim 1, wherein the printer is a digital printer to facilitate a high resolution printing on the marking surface.

7. The method of claim 1, wherein the printer prints the one or more graphics on the marking surface by diffusing a plurality of colors on the marking surface.

8. The method of claim 1, wherein printing of the one or more graphics on the marking surface includes curing the one or more graphics by treating the one or more graphics with ultraviolet rays.

9. The method of claim 1, wherein the coating is a UV durable coating.

10. The method of claim 1, wherein curing of the coating is performed for a predefined duration.

11. The method of claim 1, wherein the curing of the coating is performed after the application of the coating on the one or more graphics.

12. The method of claim 1, wherein the curing of the coating is performed during the application of the coating on the one or more graphics.
